(19) United States
(12) Patent Application Publication
(10) Pub. No.: US 2007/0019593 A1
(43) Pub. Date: Jan. 25, 2007

(54) Apparatus, system and method capable of signal strength based dynamic source routing in Ad-Hoc wireless networks

(76) Inventor: Prateep Kumar Sarkar, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,633

(22) Filed: Jun. 30, 2005

(51) Int. Cl. H04Q 7/24

(52) U.S. Cl. 370/338

(57) ABSTRACT

An embodiment of the present invention provides an apparatus, comprising a source node capable of dynamic source routing (SSDSR) to a destination node, wherein the dynamic source routing comprises: a route discovery process wherein route request packets are flooded in a network in an expanding ring search by the source node with the route request packets capable of recording information about the route including intermediate hop signal strength; and choosing an optimal path for the data traffic based on the information about the route. An embodiment of the present invention further provides when the destination node receives a Route Request packet, it is capable of responding to the source node by sending a Route Reply packet using the same route in the reverse direction that the Route Request packet took to reach the destination. Further, the dynamic source routing may further comprise a Route Maintenance process by which a node is capable of detecting that a network topology has changed and thus can no longer use a particular route and when Route Maintenance indicates that a given route has broken, the source node may either initiate a fresh Route Discovery or use another cached route to the destination node.

### BACKGROUND

Mobile Ad Hoc Wireless Networks have many applications namely in Nomadic applications, Sensor networks, and Defense Application like forward troop movements etc. In a Mobile Ad Hoc Network, due to the extremely dynamic nature of the topology changes, it is crucial that routes are chosen such that they last for long durations of time. This ensures that higher layer applications do not degrade in performance.

The emergence of nomadic applications has generated a lot of interest in next generation wireless infrastructures and in Ad Hoc Wireless Networks. Mobile Ad Hoc networks are infrastructure-less networks composed of only mobile nodes, which may be distributed dynamically, without any wired backbone or centralized entities. Each terminal in the Mobile Ad Hoc Network also has the role of the router, but the frequent changes of the terminal positions induce the waste of time, energy and computing power for updating the routing table with the paging, and also may provoke a call-dropping.

Thus, a strong need exists for an apparatus, system and method capable of signal strength based dynamic source routing in ad-hoc wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the structure of a route reply packet of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

An embodiment of the present invention provides that signal strength based dynamic source routing (SSDSR) protocol determines source routes between a source and a destination node in a Mobile Ad Hoc Wireless Network. The SSDSR protocol may have two mechanisms built into it, namely Route Discovery and Route Maintenance. In Route Discovery mechanism or process, Route Request packets are flooded in the network in an expanding ring search by the source node. Additionally, the Route Request packet may record the path traversed by it. When the destination node receives a Route Request packet, it may respond to it by sending a Route Reply packet which is sent to the source node using the same route in the reverse direction that the Route Request packet took to reach the destination. Also, each intermediate hop may mark the signal strength metric of the previous hop in the packet. Thus, when the Route Reply packet reaches the source, the source node may choose the path for the data traffic which has the best signal strength. This may imply that the route chosen will have a probability to stay alive much longer.

In an embodiment of the present invention, the SSDSR protocol uses the metric of Signal Strength and the hop count metric to choose a particular route amongst the many paths available between the source and destination. Therefore, routes determined using the SSDSR protocol may be more robust in the extremely volatile topology environment of an Ad Hoc Wireless Network.

The SSDSR protocol does value addition on the currently used Dynamic Source Routing (DSR) protocol by adding the Signal Strength Metric to the Route computation problem. Routes selected using the current DSR routing protocol are shortest path routes. Whereas the routes generated using the SSDSR are routes which have a greater probability of being valid for a longer period of time. This will increase the performance of protocols like TCP which are sensitive to packet loss.

In an embodiment of the present invention, the topology of a Mobile Ad Hoc Wireless Network may be modeled as a graph G=(V,E), where V is the set of nodes and E is the set if edges connecting the nodes. Each node is identified with a unique identifier. This identifier may be used by the routing protocols and application protocols to identify the node. The SSDSR routing protocol works in a manner very similar to the DSR routing protocol.

In an embodiment of the present invention, Route Discovery may be the mechanism by which a source node S wishing to send a packet to destination node D determines the various routes available and then chooses a particular Source Route. This source route is embedded in the packet header so that packet routing is loop free and avoiding the need for up-to-date routing information in all the intermediate nodes through which the packet is forwarded. In the SSDSR protocol, Route Discovery is done in a manner similar to DSR. This is done by flooding the network with route request packets. These route request packets reach the destination node. The destination node compiles the traversed route in a Route Reply packet and sends it back to the source node in the same reverse path. A unique aspect of the present invention provides that in SSDSR, in the reverse path, each receiving node shall put a cost in front of its node ID in the route string based on the received signal strength. In an embodiment of the present invention and not limited in this respect, the cost may have four values namely 1, 2, 3, 4; where 1 indicates the best signal quality. Once the Route Reply packets reach the source node, the Source Node can then run an algorithm to determine the route which shall have the highest link strength and the least number of hops. The route determination problem may be a LP problem, which can be also solved using an appropriate heuristic.

Route Maintenance is the mechanism by which a node S is able to detect that the network topology has changed due to which it can no longer use a particular route. When Route Maintenance indicates that a given route has broken, the source node may either initiate a fresh Route Discovery or use another cached route to D.

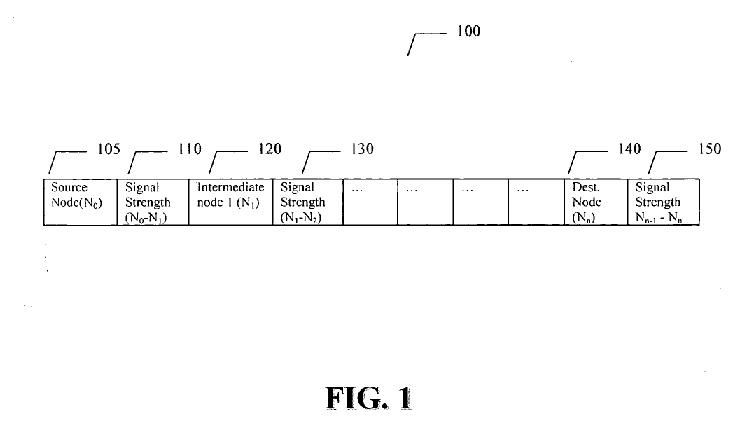

Turning now to FIG. 1, shown generally as 100, is a packet header for the Route Reply packet. FIG. 1 illustrates the contents of a Route Reply packet which may include Source Node (N0) 105, Signal Strength (N0-N1) 110; Intermediate node 1 (N1) 120; Signal Strength (N1-N2) 130; and Dest. Node (Nn) 140; and Signal Strength Nn−1-Nn 150. At the Source Node, all the Route Reply packets from different routes may converge. A heuristic to determine the signal strength of a path may be chosen to choose the signal strength of the weakest link in the path. Thus, the Source node may choose a route such that Number of Hops is minimized and the path has a high Signal strength. A route which satisfies both the conditions may be chosen as the Source Route and this Source Route will have a higher probability of staying alive for a larger period of time.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a source node capable of dynamic source routing (SSDSR) to a destination node, wherein said dynamic source routing comprises:
a route discovery process wherein route request packets are flooded in a network in an expanding ring search by said source node, with said route request packets capable of recording information about said route including intermediate hop signal strength; and
choosing an optimal path for the data traffic based on said information about said route.

2. The apparatus of claim 1, wherein said SSDSR is based on signal strength.

3. The apparatus of claim 2, wherein said information on which said path is chosen includes intermediate hop signal strength.

4. The apparatus of claim 1, wherein when said destination node receives a Route Request packet, it is capable of responding to said source node by sending a Route Reply packet using the same route in the reverse direction that the Route Request packet took to reach the destination.

5. The apparatus of claim 4, wherein said Route Reply packet includes Source Node Signal Strength; Intermediate node Signal Strength and Dest. Node Signal Strength.

6. The apparatus of claim 1, wherein said destination node compiles the traversed route in a Route Reply packet and sends it back to said source node in the same reverse path and each receiving node places a cost in front of its node ID in the route string based on the received signal strength.

7. The apparatus of claim 1, wherein a source route is embedded in a packet header so that packet routing is loop free and avoiding the need for up-to-date routing information in all the intermediate nodes through which the packet is forwarded.

8. The apparatus of claim 1, wherein a heuristic to determine the signal strength of a path is chosen to choose the signal strength of the weakest link in the path.

9. The apparatus of claim 8, wherein said source node chooses a route such that the Number of Hops is minimized and the path has a high Signal strength.

10. The apparatus of claim 1, wherein said dynamic source routing further comprises a Route Maintenance process by which a node is capable of detecting that a network topology has changed and thus can no longer use a particular route.

11. The apparatus of claim 10, wherein when Route Maintenance indicates that a given route has broken, said source node may either initiate a fresh Route Discovery or use another cached route to said destination node.

12. A method of dynamic source routing from a source node to a destination node, comprising:
utilizing a route discovery process wherein route request packets are flooded in a network in an expanding ring search by said source node with said route request packets capable of recording information about said route including intermediate hop signal strength; and
choosing an optimal path for the data traffic based on said information about said route.

13. The method of claim 12, further comprising choosing said path for said data traffic based on signal strength.

14. The method of claim 12, further comprising including intermediate hop signal strength information into said information about said route.

15. The method of claim 12, further comprising responding to said source node by sending a Route Reply packet using the same route in the reverse direction that the Route Request packet took to reach the destination.

16. The method of claim 12, further comprising compiling, by said destination node, the traversed route in a Route Reply packet and sending it back to said source node in the same reverse path.

17. The method of claim 12, further comprising using a heuristic to determine the signal strength of a path to choose the signal strength of the weakest link in the path.

18. The method of claim 14, further comprising choosing by said source node a route such that the Number of Hops is minimized and the path has a high Signal strength.

19. The method of claim 12, further comprising utilizing a Route Maintenance process by which a node is capable of detecting that a network topology has changed and thus can no longer use a particular route.

20. The method of claim 19, wherein when Route Maintenance indicates that a given route has broken, said source node may either initiate a fresh Route Discovery or use another cached route to said destination node.

21. An article comprising a machine-accessible medium having one or more associated instructions, which if executed, results in dynamic source routing from a source node to a destination node by controlling a route discovery process wherein route request packets are flooded in a network in an expanding ring search by said source node with said route request packets capable of recording information about said route including intermediate hop signal strength; and
choosing the path for the data traffic based on said information about said route.

22. The article of claim 21, wherein said article further controls compiling, by said destination node, the traversed route in a Route Reply packet and sending it back to said source node in the same reverse path.

23. The article of claim 21, further comprising using a heuristic to determine the signal strength of a path to choose the signal strength of the weakest link in the path.

24. The article of claim 21, further comprising controlling a Route Maintenance process by which a node is capable of detecting that a network topology has changed and thus can no longer use a particular route and wherein said source node may either initiate a fresh Route Discovery or use another cached route to said destination node.
